(19) United States
(12) Patent Application Publication
(10) Pub. No.: US 2008/0110526 A1
(43) Pub. Date: May 15, 2008

(54) Fixation Structure for a Blade Body of a Planing Cutter and a Spiral Planing Cutter

(76) Inventors: Wei Cong, Weihai City (CN); Jifu Zou, Wendeng City (CN)

Correspondence Address: HOFFMANN & BARON, LLP, 6900 JERICHO TURNPIKE, SYOSSET, NY, 11791, US

(21) Appl. No.: 11/937,556

(22) Filed: Nov. 9, 2007

(30) Foreign Application Priority Data
Nov. 10, 2006 (CN) 200620157901.2

(51) Int. Cl. B27G 13/04; B26D 7/26

(52) U.S. Cl. 144/230; 144/225; 407/40

(57) ABSTRACT

The present invention discloses a fixation structure for a blade body of a planing cutter, wherein the planing cutter comprises a cutter body, a blade body, and a plurality of screw connectors. The cutter body is provided on its outer peripheral surface with a cutter seat used for mounting the blade body on which a blade of hard alloy is welded, a cooperating and positioning structure is provided between the joint surfaces of the blade body and the cutter seat, and the blade body is directly threadedly connected on the mounting seat of the cutter body through a plurality of screw connectors. Such fixation structure is simple and the replacement of the blade body is convenient, and is adapted for flat planing cutters and spiral planing cutters. The present invention also discloses a spiral planing cutter which is adapted for driving devices such as manual or electric planers, wherein the spiral planing cuter comprises a spiral cutter body which is provided on its outer peripheral surface with a plurality of spiral surfaces at equal intervals and also comprises a flat and straight blade body on which a strip-shaped body of hard alloy is welded and a plurality of screw connectors through which the flat and straight blade is fixedly connected to the spiral surface, wherein a positioning structure is provided between the blade body and the spiral surface.

This application claims priority based on Chinese Patent Application No. 200620157901.2 filed on Nov. 10, 2006 which is incorporated herein by reference.

### BACKGROUND OF THE INVENTION

1. Technical Field

The present invention relates to a fixation structure for a blade body of a planing cutter. The present invention also relates to a spiral planing cutter which is applicable to planing (milling) process of wood materials for purpose of obtaining a plane.

2. Brief Description of the Related Art

The present processing cutters for wood planes include flat planing cutters and spiral planing cutters. The cutting blade of the flat planing cutter is linearly contacted with the workpiece to be processed during operation, therefore the cutting resistance is large, and thus a high power motor is required, the nose is loud and more energy is needed. The spiral planing cutter adopting a spiral design permits point contacts between the planing cutter and the workpiece to be processed when planing, which facilitates the processing and saves energy.

Chinese Patent for Utility Model No. ZL01222134.1 discloses a fixation device for a cutter of a planer comprising a stem body, a cutter, and a protection cover. A plurality of spiral positioning grooves, in which a shoulder and a stop edge are provided, are provided on the outer peripheral surface of the stem body. The cutter provided with barbs thereon is firmly fixed through the respective snap fastenings between the shoulder and the barbs and between the stop edge and the cover body. However, because of the split structure of the cutter and the protection cover, the cutter is indirectly fixed on the stem body by means of the snap fastening of the protection cover, which accordingly requires greater clamping force and more pieces of protection cover. As a result, it is time and labor consuming and inconvenient to operate when replacing the cutter due to abrasion.

Chinese Patent for Utility Model No. 200520000023.9 discloses a cutter shaft device for planer comprising at least one planing blade, a cutter seat cooperating with the planing blade, two positioning rings, at least one blade fixing plate, and a plurality of screw connectors. The planing blade has a blade body extending axially and is provided at the both ends with positioning holes respectively. The cutter seat is provided with a mounting surface extending axially and a plurality of internal screw holes formed concavely and respectively in the mounting surface and with axial intervals therebetween. The two positioning rings are respectively provided on both sides of the cutter seat with positioning studs corresponding to the positioning holes of the planing blade. The blade fixing plate is cooperating to the mounting surface of the cutter seat and is provided thereon with a plurality of through holes corresponding to the internal screw holes in the cutter seat. The planing cutter is mounted across the positioning rings with its positioning holes on both ends embedded by the adjacent positioning studs. The blade fixing plate is mounted to cover the planning blade. The screw connectors are threadly connected with the screw holes in the cutter seat after passing through the through holes in the blade fixing plate respectively. The disclosure herein is the type of the flat planing cutter, wherein the blade is indirectly fixed on the cutter seat through the fixing cover plate and is positioned through the positioning rings on both ends, therefore the fixation structure for the cutter has a complicated construction and the replacing operation of the cutter is inconvenient as well.

Therefore, there is a need to improve the existing fixation structures of both flat planing cutter and spiral planning cutter so as to simplify the fixation structure and make the replacing operation of the planning cutter easy.

### SUMMARY OF THE INVENTION

The object of the present invention is to overcome the defects in the prior art, and the present invention provides, on one aspect, a simple fixation structure for a blade body of the planing cutter with a facilitated operation to replace the blade body and provides, on another aspect, a spiral planing cutter having such blade structure.

To achieve the abovementioned object, the present invention provides a spiral planing cutter comprising a spiral cutter body which is provided with spiral surfaces on its outer periphery, wherein it further comprises a flexible blade body with a strip-shaped blade of hard alloy welded thereon, and a plurality of screw connectors used to press the blade body tightly against the spiral surface, wherein a corresponding and positioning structure is provided between the blade body and the spiral surface.

Compared with the prior art, the fixation structure for blade body of the planning cutter according to present invention has advantages that the blade of hard alloy is welded on the blade body to form the planing blade, so that the planing blade can be directly fixed on the cutter seat of the cutter body through screw connectors. In addition, because the corresponding and positioning structure constructed by a position stage and a groove is provided between the joint surfaces of the cutter body and the cutter seat, additional positioning components are not required, which simplifies the fixation structure and facilitates the replacing of the cutter body. Beside the advantages brought by the fixation structure for blade body above mentioned, the spiral planning cutter according to the present invention has further advantages that the blade body can be flat and straight until fixed on the spiral surface. In this way, the straight stripe-shaped blade of hard alloy can be easily welded on the blade body and then bended, along with the cutter body, to a spirally twisted shape attached with the spiral surface of the spiral cutter body, so that the blade of hard alloy can be independently applied to the conventional spiral planing cutters. And due to the one-piece structure constructed by the blade of hard alloy and the blade body, the blade of hard alloy will not be broken when twisting along with the blade body.

It is understood that the general description above and the detailed description below are representative and descriptive with purpose of further describing the present invention claimed herein.

Other features and advantages of the present invention are set forth in the following description, and in Part will be obvious from the description, or can be learnt from the practice of the present invention. The objects and other advantages of the present invention can be understood and obtained from the following text of the description, claims and the structures specially given by the accompanying drawings.

### BRIEF DESCRIPTION OF THE DRAWINGS

The accompanying drawings, which are included to provide a further understanding of the description are incorporated and constitute as a part of this application, illustrate some embodiments of the present invention and can be used, together with the description, for explaining the principles of the present invention, in which:

FIG. 1 is a perspective view of the spiral planing cutter of the present invention illustrating the fixation structure of the blade body of the planing cutter of the present invention;

FIG. 2 is an exploded perspective view of the spiral planing cutter of the present invention;

FIG. 3 is a perspective view of the fixation structure of the blade body of the planing cutter and the blade body of the spiral planing cutter of the present invention; and

FIG. 4 is a sectional view taken along with C-C in FIG. 3.

### DETAILED DESCRIPTION OF THE PREFERRED EMBODIMENTS

Hereafter, the embodiments of the present invention will be explained in details combining with the figures.

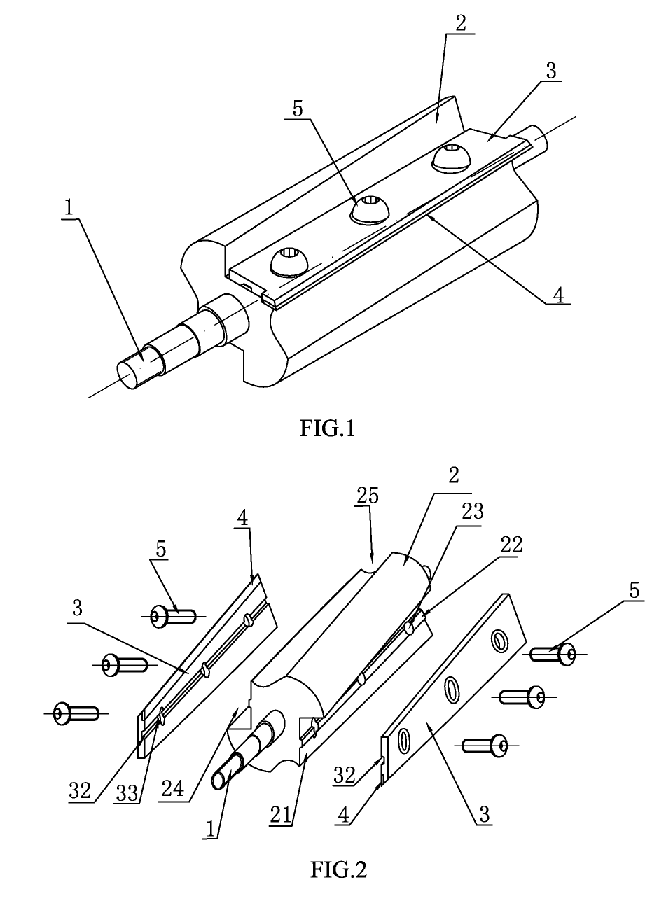

As shown in FIGS. 1 and 2, the spiral planing cutter according to the present invention comprises a spiral cutter body 2, a blade body 3 and a plurality of fastening screws 5, wherein a driving shaft 1 connected to a driving device such as an electric planer is provided on one end of the spiral cutter body 2, and the spiral cutter body 2 has a substantially cylinder-shaped outer peripheral surface provided concavely with at least one group of cutter seats 24 and chip discharging grooves 25 adjacent thereto. The cutter seat 24 and the chip discharging groove 25 are spirally extended along the length direction of the spiral cutter body 2, and the bottom surface of the cutter seat 24 is formed with spiral surface 21 which is provided thereon with positioning stage 22, the positioning stage is extended on the spiral surface 21 along the direction in which the spiral surface 21 extends, i.e., the spiral positioning stage. The positioning stage 22 is provided substantially in the middle of the spiral surface in the length direction. In addition, the spiral surface 21 is provided with a plurality of screw holes 23 having intervals between each other used for setting the screw connectors such as the fastening screws 5.

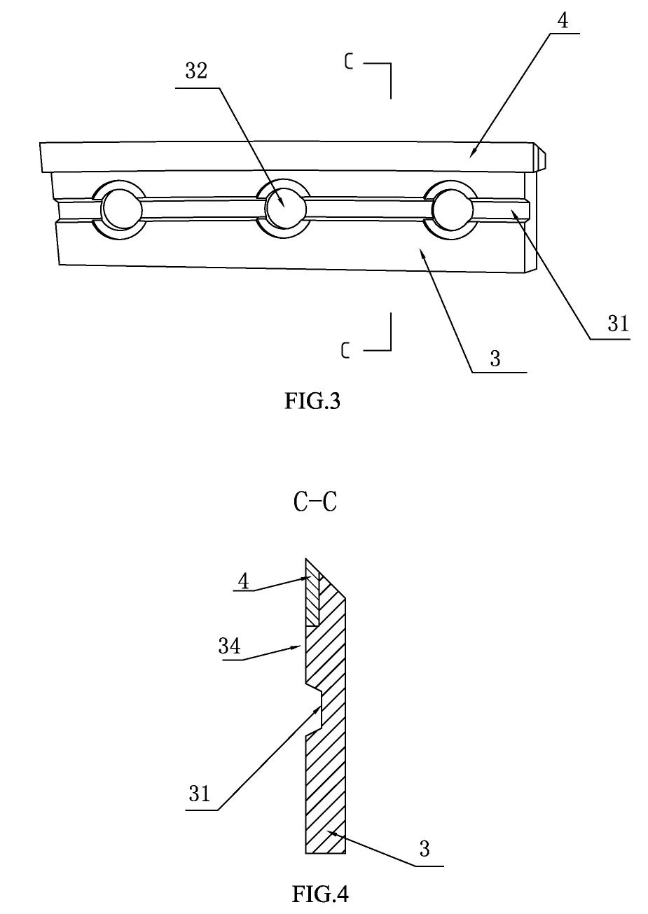

As shown in FIGS. 3 and 4, the blade body 3 is flat and straight under the condition of assembly so that the blade of hard alloy 4 can be easily welded thereon. The blade body 3 is provided with the groove 31 on the bottom surface 34. The groove 31 extends in the length direction of the blade body 3 to cooperate with the positioning stage 22. The blade body 3 is formed with holes 32 used for the passage of the screws 5. It could be found that, owing to its flexibility, the blade can be spirally twisted to a certain extent under the effect of the fastening screws, and also owing to being integrally welded to the blade body, the blade of hard alloy thereon is accordingly spirally twisted without breakage. FIG. 1 shows the assembly combination state of the spiral planing cutter, wherein the blade body 3 is pressed and fastened on the cutter seat 24 of the spiral cutter body through a plurality of fastening screws 5, the blade body 3 is bent with its bottom surface 34 attached with the spiral surface 21, and the positioning stage 22 cooperates with the groove 31 so that the object of securing the blade body onto the cutter seat is achieved.

It can be easily seen by those skilled in the art that the straight strip-shaped blade of hard alloy can be easily welded on the flat and straight blade, and the cooperating and positioning structure of positioning stage and groove provided on the engaging surface between the blade body and the cutter seat causes that it is unnecessary to provide additional positioning members. Of course, such cooperating and positioning structure can be also achieved in this way that the orientation stage is provided on the blade body, while the spiral groove is provided on the cutter seat. It can also be other structures in which a protrusion and a concave cooperate with each other can be used. Further, this structure in which the blade of hard alloy is welded on the flat and straight blade body and the cooperation and positioning structure is provided on the engaging surface between the cutter body and the cutter seat is used in a flat planing cutter, and therefore deforming the blade body to match the spiral surface by the fastening force of the fastening screws is not required, which facilitates the operation. In addition, to achieve the purpose of anti-loosening, a pad such as spring pad and the like can be provided on the fastening screws.

The above are only preferable embodiments of the present invention but not limited to it. For those skilled in the art, various modifications and variations can be made to the present invention. All modifications, substitutions and improvements made under the spirit and principle of the present invention should be included within the scope of the claims of the present invention.

What is claimed is:

1. A spiral planing cutter comprising:
a spiral cutter body which is provided with a spiral surface on its outer periphery; and
a flexible blade body integrally engaged with a strip-shaped blade of hard alloy thereon.

2. The spiral planing cutter according to claim 1, further comprises a plurality of screw connectors used to press the blade body tightly against the spiral surface.

3. The spiral planing cutter according to claim 2, wherein a cooperating and positioning structure is provided between the blade body and the spiral surfaces.

4. The spiral planing cutter according to claim 1, wherein the cooperating and positioning structure comprises a groove located on the blade body and extended in a length direction of the blade body and a positioning stage capable of cooperating with the groove on the spiral surface.

5. The spiral planing cutter according to claim 1, wherein the flexible blade body is flat and straight.

6. The spiral planing cutter according to claim 1, wherein the spiral cutter body has a substantially cylinder-shaped outer peripheral surface, the outer peripheral surface is concavely provided with at least one group of cutter seats and chip discharging grooves adjacent to the cutter seats, the cutter seats and the chip discharging grooves spirally extend in a length direction of the cutter body, the spiral surfaces are formed on a respective bottom surface of each of the cutter seats, and one end of the spiral cutter body has a shaft connected to a driving device.

7. The spiral planing cutter according to claim 6, wherein there are two groups of cutter seats and chip discharging grooves provided concavely on the outer peripheral surfaces.

8. A fixation structure for a blade body of a planing cutter comprising a cutter body, a blade body, and a plurality of screw connectors, in which the cutter body is provided on an outer periphery with cutter seats used to mount the blade body, wherein a blade of hard alloy is integrally engaged with the blade body.

9. The fixation structure for a blade body of a planing cutter according to claim 8, wherein the blade body contact with the cutter seats, a cooperating and positioning structure is provided on a contacting surface therebetween.

10. The fixation structure for a blade body of a planing cutter according to claim 9, wherein the blade body is pressed tightly against the cutter seats of the cutter body through the plurality of screw connectors.

11. The fixation structure for a blade body of a planing cutter according to claim 8, wherein the cooperating and positioning structure comprises a groove located on a contacting surface of the blade body and a positioning stage located on a contacting surface of the cutter seat and capable of cooperating with the groove.

12. The fixation structure for a blade body of a planing cutter according to claim 8, wherein the cooperating and positioning structure comprises a positioning stage located on a contacting surface of the blade body and extended in a length direction of the blade body and a groove provided on a contacting surface of the cutter seat and capable of cooperating with the positioning stage.

13. The fixation structure for a blade body of a planing cutter according to claim 8, wherein an end of the cutter body has a driving shaft, the cutter body is concavely provided on an outer peripheral surface with at least one group of cutter seats and chip discharging grooves adjacent to the cutter seats, the cutter seats and the chip discharging grooves are extended in a length direction of the cutter body, and screw holes used for respectively mounting the plurality of screw connectors are provided on the cutter seats.

14. The fixation structure for a blade body of a planing cutter according to claim 13, wherein there are at least two groups of the cutter seats and the chip discharging grooves which are all disposed on the periphery.
